(19) United States
(12) Patent Application Publication
(10) Pub. No.: US 2021/0191774 A1
(43) Pub. Date: Jun. 24, 2021

(54) CONTROLLING QUALITY-OF-SERVICE FOR INPUT/OUTPUT STREAMS ASSOCIATED WITH KEY-VALUE DATABASE

(71) Applicant: Micron Technology, Inc., Boise, ID (US)

(72) Inventors: Kumar VKH. Kanteti, Sunnyvale, CA (US); Pierre Labat, Campbell, CA (US)

(21) Appl. No.: 16/719,298

(22) Filed: Dec. 18, 2019

(51) Int. Cl. G06F 9/50; G06F 16/22; G06F 16/2455

(52) U.S. Cl. CPC G06F 9/5011; G06F 2209/501; G06F 16/24568; G06F 16/2228

(57) ABSTRACT

One or more input/output streams associated with one or more key-value databases can be received. Respective tags of the one or more input/output streams can be inspected. Based on identification data obtained from inspecting the respective tags, respective amounts of bandwidths to be provisioned to the one or more input/output streams can be determined in order to satisfy a threshold criterion pertaining to a predetermined quality-of-service (QoS) parameter associated with the one or more input/output streams. The one or more input/output streams with the respective amounts of provisioned bandwidths across the one or more key-value databases can be dynamically throttled to regulate processing time for input/output operations in the one or more input/output streams in accordance with the QoS parameter.

### TECHNICAL FIELD

The present disclosure generally relates to a memory sub-system, and more specifically, relates to operations of a persistent storage architecture.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various implementations of the disclosure.

FIG. 1 illustrates an example computing system that includes a host system coupled with a memory sub-system in accordance with some embodiments of the present disclosure.

FIG. 2 illustrates bandwidth provisioning and dynamic throttling by a quality-of-service (QoS) module that receives input/output (I/O) streams from one or more key-value databases (KVDBs), in accordance with some embodiments of the present disclosure.

FIG. 3 illustrates a storage stack architecture with built-in QoS control, in accordance with some embodiments of the present disclosure.

FIG. 4 illustrates a grouping scheme for I/O tags to facilitate QoS control, in accordance with some embodiments of the present disclosure.

FIG. 5 is a flow diagram of an example method of controlling QoS for database I/O streams, in accordance with some embodiments of the present disclosure.

FIG. 6 is a block diagram of an example computer system in which implementations of the present disclosure can operate.

### DETAILED DESCRIPTION

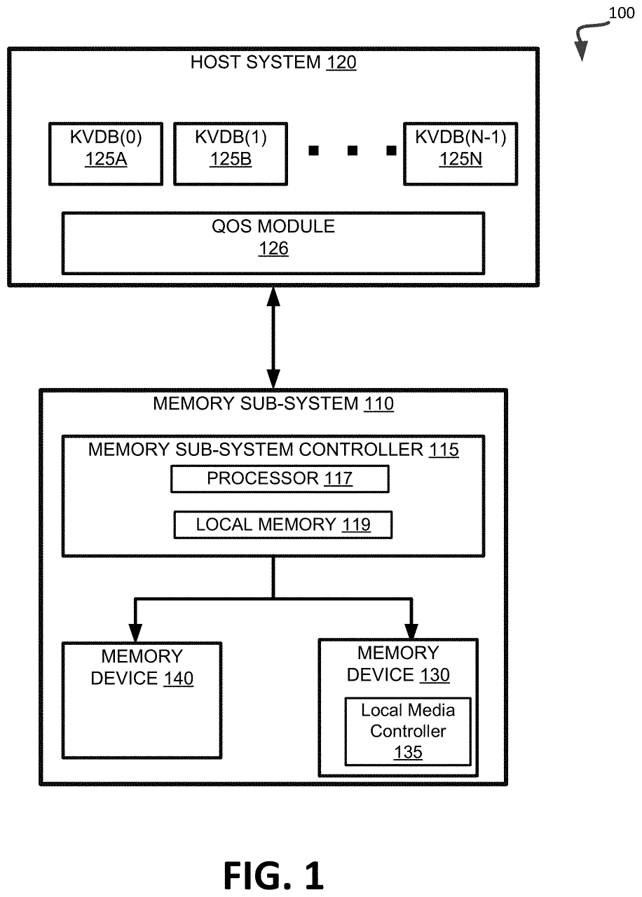

Aspects of the present disclosure are directed to implementing a Quality-of-Service (QoS) feature in a storage architecture that is built based on type of non-relational database, known as a key-value database (KVDB). The QoS feature can provide consistent bandwidth and predictable latency to KVDB input/output (I/O) streams placed in a processing queue that can span multiple KVDBs. A KVDB is an instance of a collection of key-value sets (kvset) (also known as a key-value store (KVS)) in a host system coupled to a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices that store data. The host system can provide data to be stored at the memory sub-system and can request data to be retrieved from the memory sub-system.

Key-value data structures accept a key-value pair (i.e., including a key and a value) and are configured to respond to queries pertaining to the key. Key-value data structures may include such structures as dictionaries (e.g., maps, hash maps, etc.) in which the key is stored in a list that links (or contains) the respective value. While these data structures are useful in-memory (e.g., in main or system state memory as opposed to long-term storage), storage representations of these data structures in persistent storage (e.g., long-term on-disk storage) may be inefficient.

In some embodiments, a KVDB uses a tree data structure (such as, log-structured merge-tee or LSM tree) to increase efficiency in persistent storage architecture. A tree data structure includes nodes with connections between a parent node and a child node based on a predetermined derivation of a key. The nodes include temporally ordered sequences of KVSs. The KVSs contain key-value pairs in a key-sorted structure. KVSs are also immutable once written. The KVS tree achieves high write-throughput and improved searching by maintaining KVSs in nodes. The KVSs include sorted keys, as well as, in an example, key metrics (such as bloom filters, minimum and maximum keys, etc.), to provide efficient search. In many examples, KVS trees can improve upon the temporary storage issues of other types of tree structures by separating keys from values and merging smaller KVS collections. Additionally, the KVS trees may reduce write amplification through a variety of maintenance operations on KVSs. Further, as the KVSs in nodes are immutable, issues such as write wear on persistent storage devices (e.g., solid state devices (SSDs)) may be managed by the data structure, reducing garbage collection activities of the device itself. This has the added benefit of freeing up internal device resources (e.g., bus bandwidth, processing cycles, etc.) that result in better external drive performance (e.g., read or write speed).

While KVS trees are flexible and powerful data structures for a variety of storage tasks, greater efficiencies may be gained by combining multiple KVS trees into a KVS tree database, referred to as KVDB. Input/output (I/O) streams (i.e., a sequence of I/O operations between a source (e.g., a host system) and a destination (e.g., persistent storage media)) associated with a KVDB include both user-initiated I/O streams as well as administrative I/O streams to maintain the KVDB. User I/O streams can include I/O operations associated with applications running on the host system that need to access data in the KVDB. Administrative I/O streams can include I/O operations that are part of internal maintenance-related operations periodically run by the system administrator (manually or automatically) in order to efficiently organize the data structure within a KVDB.

Without proper internal maintenance, the shape (i.e. the hierarchy between different nodes) of the tree data structure in a KVDB becomes non-optimal, and it can take longer to complete a user-initiated I/O operation, i.e. the latency of a user-initiated operation can be unacceptably high, which in turn negatively impacts the QoS that the persistent storage architecture can deliver to the user. QoS is a common industry term that is frequently used to describe a distribution of operational latencies within a system. QoS control is a feature that is not available in many of the conventional databases (including conventional non-relational databases, some of which are based on open source software). Conventional databases often place user-initiated operations (e.g., read and/or write requests) and internal maintenance operations in the same processing queue. Alternatively, in some conventional databases, user-initiated operations are always treated with higher priority than the internal maintenance operations, resulting in gradual degradation of latency because of poorly maintained data structure. None of these approaches offers fine-grained dynamic control of I/O processing time to guarantee predictable latency for user-initiated I/O streams. Moreover, in existing KVS-based databases, KVSs are created on the file system, and there is no mechanism to achieve QoS control spanning multiple instances of KVDBs.

Aspects of the present disclosure address the above and other deficiencies by integrating a QoS module with the storage stack that handles database I/O streams. A storage stack is a bundle of software implementing a storage engine that a database management system uses to update data in a database. The QoS module dynamically provisions bandwidth to I/O streams associated with KVDBs based on information contained in tags with which the I/O streams are labeled. The QoS module throttles and/or multiplexes I/O streams across one or more KVDBs. I/O throttling regulates processing time for I/O operations included in the I/O streams. Multiplexing involves efficiently dividing processing time among multiple I/O streams.

An advantage of the present disclosure is that the described system enables a user to select tags to label user-initiated I/O streams with varying levels of priority. The system also allows KVDB administrators to label internal maintenance-related I/O streams so that they can be differentiated from the user-initiated I/O streams. Based on the tag information, a QoS module can determine an appropriate throttling and/or multiplexing scheme so that the storage stack can deliver a target QoS of an application. By integrating QoS control with the storage stack, application-to-media I/O path length is significantly reduced. I/O path length reduction results in decreased I/O latency as well as reduction of bandwidth overprovisioning cost.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transitor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM), and a cross-point array of non-volatile memory cells.

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA) namespace) and a physical address and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

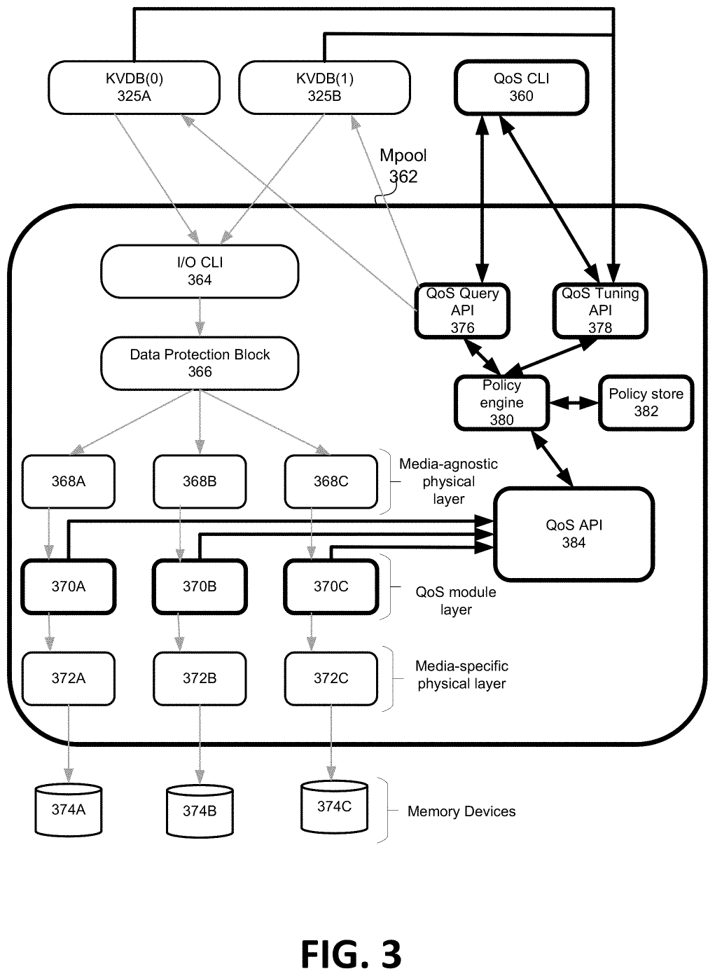

The host system 120 includes one or more instances of KVDBs 125A to 125N. The host system 120 also includes a QoS module 126 that can recognize, based on tags, which I/O operations are user-initiated and which I/O operations are related to internal maintenance of data structure in the KVDBs. The QoS module can be included in a memory management system (e.g., mpool 362 shown in FIG. 3). The controller 115 can include a processor 117 (processing device) configured to execute instructions stored in local memory 119 for performing some of the operations described herein.

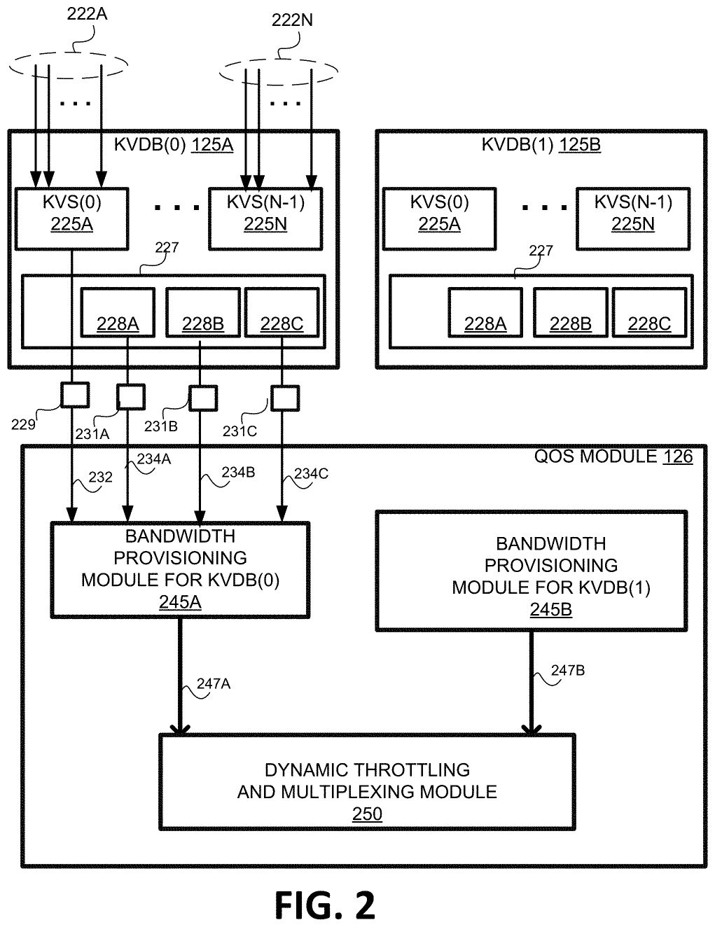

FIG. 2 illustrates bandwidth provisioning and dynamic throttling by a quality-of-service (QoS) module 126 that receives I/O streams from one or more key-value databases (KVDBs). FIG. 2 shows only two instances of a KVDB (i.e., KVDB(0) and KVDB(1)), though the scope of the disclosure is not limited to any specific number of KVDBs. For clarity, the arrows showing I/O flow are shown only for KVDB(0) (125A), though KVDB(1) (125B) and any other KVDB instances (not shown) can also have I/O flows directed to the QoS module 126. As described above, each KVDB includes one or more KVSs 225A to 225N. One or more I/O operation requests 222A to 222N from applications running on the host system involve accessing corresponding KVSs 225A to 225N. I/O operation requests are put into I/O streams. A memory management system (e.g., mpool 362 shown in FIG. 3) enables one or more tags to be associated with an I/O stream, e.g., via command line interface such as component 364 shown in FIG. 3. For example, I/O stream 232 can include a tag 229 that can inform the QoS module 126 of the respective priority levels of the I/O operations in that I/O stream. Note that tag 229 can comprise multiple tags containing information about different priority levels of different I/O operations. In this example, I/O stream 232 has only user-initiated I/O operations and no internal-maintenance-related I/O operations (i.e. no operations that are related to maintaining the hierarchy of nodes in the tree data structure within the KVDBs).

Each KVDB can have an internal maintenance module 227, which can be a dirty data cache module. Each internal maintenance module includes data organization components 228 (e.g., 228A, 228B, 228C—though three components are shown in the example, any arbitrary number of components can be used) to re-organize the KVSs 225A to 225N periodically. Data organization components 228 perform various maintenance operations on the tree data structure to keep the optimal shape of the tree. In certain embodiments, components 228A, 228B and 22C can be logging module, ingest module etc. I/O streams 234A, 234B and 234C indicate I/O streams that can include both user-initiated I/O operations (e.g., 222A to 222N) and internal maintenance-related I/O operations. Tags 231A, 231B and 231C contain relevant information to differentiate the user-initiated I/O operations from the internal-maintenance related I/O operations. The KVDBs are mapped along with their corresponding I/O streams (with the respective tags) into the QoS module 126. For example, bandwidth provisioning modules 245A and 245B map KVDB(0) and KVDB(1) respectively. Based on inspecting the tags and the information contained in the tags, the bandwidth provisioning module 245A for KVDB(0) can allocate available bandwidth between the I/O streams 232, 234A, 234B and 234C (for example, prioritizing user-initiated I/O operations over internal-maintenance-related I/O operations when nodes of the tree data structure are optimally distributed, or prioritizing internal-maintenance-related I/O operations over user-initiated I/O operations when write or read latency suffers because of the sub-optimal distribution of the nodes of the tree data structure). For example, in one scenario, when internal maintenance-related I/O operations in I/O stream 234C are prioritized, I/O stream 232 can have 10% bandwidth, I/O streams 234A and 234B can each have 10% bandwidth, and the rest of the 70% bandwidth can be allocated to I/O stream 234C. This percentage allocation can be accomplished with weighted round robin or other techniques. Module 245A can instruct dynamic throttling and multiplexing module 250 to service the I/O streams according to those percentages. Note that these example percentages are for illustrative purpose and do not limited the scope of the disclosure. The QoS module can dynamically vary these percentages of allocated bandwidths based a predetermined QoS parameter associated with the I/O streams. In one example, QoS tuning API module 378 shown in FIG. 3 can control the dynamic bandwidth allocation function.

QoS module 126 includes bandwidth provisioning modules corresponding to each KVDB. For example, bandwidth provisioning module 245B can allocate available bandwidth between the I/O streams (not shown) coming from KVDB(1) (125B). Depending on the number of KVDBs, the QoS module 126 can distribute the total available bandwidth between I/O streams directed to a dynamic throttling and multiplexing module 250. For example, I/O stream 247A can direct all I/O streams from KVDB(0) to the dynamic throttling and multiplexing module 250 including all the information from the tags 229, 231A, 231B and 231C. Similarly, I/O stream 247B can direct all I/O streams from KVDB(1) to the dynamic throttling and multiplexing module 250 including all the tag information (not shown). The dynamic throttling and multiplexing module 250 regulates processing time for input/output operations in the one or more input/output streams in accordance with a predetermined QoS parameter, as described in further detail below.

FIG. 3 illustrates a storage stack architecture with built-in QoS control, in accordance with some embodiments of the present disclosure. Specifically, the QoS module layer (370A, B, C) in the I/O stream path from KVDBs (325A, B) to memory devices (374A, B, C) illustrates integration of the QoS module 126 (shown in FIGS. 1 and 2) in the storage stack. In this example embodiment, the thicker darker arrows indicate information flow related to QoS control, while the thinner lighter arrows indicate I/O streamflow from the KVDBs to media 374A, 374B, 374C. Though three media are shown for illustrative purposes, any number of media can be used. Media 374A-C can be the memory devices 140 shown in FIG. 1. Also, KVDBs 325A and 325B can be KVDB(0) 125A and KVDB(1) 125B shown in FIGS. 1 and 2. Note that though just two KVDBs are shown in FIG. 3, the QoS components can be integrated with any number of KVDBs coupled with any number of media.

Specifically, block 360 is a command line interface (CLI) for an administrator to configure a QoS parameter so that the QoS module 126 (shown in in FIG. 2) can adopt an appropriate throttling scheme for the incoming I/O streams. The QoS parameter can be associated with latencies of one or more I/O streams. For example, if latency of one or more I/O streams do not meet a threshold latency, then the storage architecture fails to deliver the target QoS parameter configured by the administration. The QoS module can dynamically change the I/O processing time of one or more I/O streams to meet the configured QoS parameter.

Components of the QoS module 126 can reside within a memory pool (mpool) 362. A memory pool is a storage module which manages the different memory devices. In the I/O path as shown in FIG. 3, mpool can write data to memory devices and perform data protection operations. Mpool 362 can have another command line interface 364 to assign tags to I/O streams coming from the KVDBs 325A and 325B. Optionally, a data protection block 366 is included in the I/O path. The data protection block can be based on Erasure Coding (EC) or other type of data protection schemes such as redundant array of independent disks (RAID). QoS module layer (370A, 370B and 370C) is implemented between a media-agnostic generic physical layer (368A, 368B and 368C) and a media-specific physical layer (372A, 372B and 372C) that acts as an interface adapter depending on the type of media. For example, if the media is SSD, the media-specific physical layer can be NVMe SSD. The media-specific physical layer directs interfaces with the physical media, while the media-agnostic generic physical layer provides interfaces to the QoS module layer (370A, B, C) within the mpool. The QoS module layer implements the actual throttling mechanism using queues. The QoS module intercepts I/O streams to inspect the tags, and posts the I/O operations to the throttling queue. The QoS module can also provide system overview by providing statistics about latency and bandwidth distribution among various I/O streams tagged with various tags.

In addition to the QoS layer, the internal architecture of the QoS module can comprise a policy engine 380, a policy store 382 and various application programming interfaces (APIs), such as QoS API 384, QoS query API 376, and QoS tuning API 378.

The policy store 382 provides persistent data storage for the QoS module. Data from the policy store 382 is read when the storage stack is loaded. When there is no policy stored, a default policy (which can be hardcoded) is loaded. An administrator can have privileges to modify policy and make a policy persistent. Policy engine 380 maintains in-memory data structure of the policy store 382. An API can query the policy engine 380 to translate an I/O tag to a run-time throttling queue.

The QoS API 384 defines interfaces to communicate with the policy engine in the I/O path. QoS query API gives users and/or administrators interfaces to query policy. For example, system performance statistics can be reported via the QoS API. QoS tuning API 378 is responsible for automatic tuning of different types of I/Os, such as user-initiated I/Os and internal maintenance-related I/Os. For example, if KVDB determines a need to rebalance between internal maintenance-related I/Os and user-initiated I/Os to improve the tree structure in the database, such rebalancing requests are sent to the QoS tuning API, along with the bandwidth allocation between internal maintenance-related I/Os and user-initiated I/Os. The QoS Tuning API module processes the rebalancing requests and redistribute bandwidth across throttling queues. The new bandwidth allocation information is then sent to the policy engine. In some embodiments, the KVDBs get feedback from the QoS. The KVDBs use the feedback to know the effect of QoS tuning. For example, feedback may include the current throughput and I/O latency for each I/O stream.

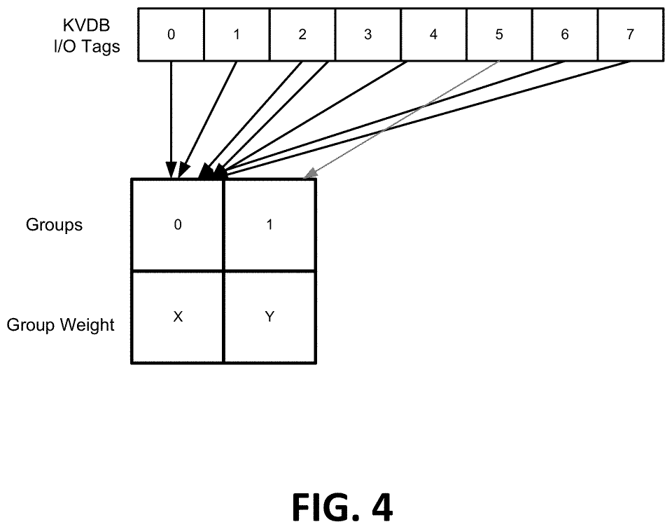

FIG. 4 illustrates a grouping scheme for I/O tags to facilitate QoS control, in accordance with some embodiments of the present disclosure. I/O tags of a KVDB can be grouped. A user can select, via an interface, a tag for which an appropriate priory level already preset. The user can also select a group where the tag will be assigned to. The groups can have predetermined weights. While individual tags with different priory levels offer the finest granularity to allocate bandwidth, it can be difficult for the KVDB to determine the best percentage of bandwidth for each tag. Therefore, grouping provides an alternative way of efficient bandwidth allocation. For example, FIG. 4 shows 8 I/O tags marked (0, 1, . . . , 7). I/O tags marked 0, 1, 2, 3, 4, 6 and 7 are placed in group 0 that is assigned collectively X% of bandwidth. These tags can cover all the I/Os except the internal maintenance-related I/Os. I/O tag 5 is placed in group 1 that is assigned Y% of bandwidth (where X+Y=100) and cover all the internal maintenance-related I/Os. Note that number of groups can be higher than two as long as the allocated bandwidth percentages add up to 100%. To find the weight percentage of bandwidth allocation to different groups of tags, a processing logic circuit implementing the QoS module 126 can use various mathematical techniques, such as weighted round robin (WRR). The selected technique can depend on the number of groups.

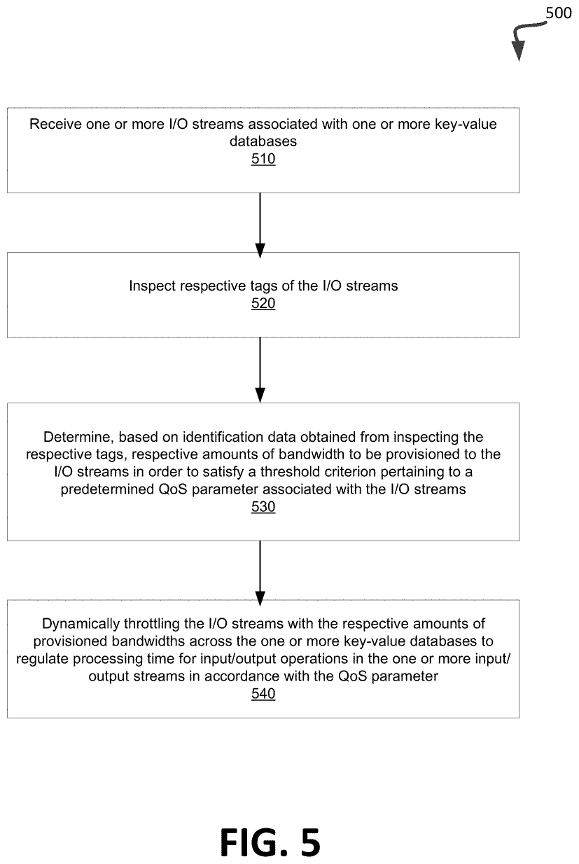

FIG. 5 is a flow diagram of an example method 500 of controlling QoS for database I/O streams, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 can be performed by the QoS component 126 of the host system 120 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic receives one or more I/O streams associated with one or more KVDBs. The I/O streams can be originated at the host system running user-initiated applications. At least one of the I/O streams includes one or more user-initiated I/O operations associated with accessing data stored in a memory sub-system coupled with one or KVDBs. Some of the I/O streams can originate in the KVDBs themselves and can include internal maintenance-related input/output operations for one or more KVDBs. The I/O streams are labeled with tags. A memory management system containing the QoS module 126 can provide an interface to a user to tag user-initiated I/O operations, where the tags have identification data about the I/O stream. An example of identification data is which application executed at the host system initiated the I/O operations in an I/O stream. Another example of identification data contained in the tag can be which KVDB is associated with the respective I/O streams.

In certain implementations, the command line interface 364 shown in FIG. 3 enables a user to select an appropriate tag for an I/O stream. The tags can be associated with varying priority labels, and the user can select a tag with the appropriate priory level to label an I/O operation in an I/O stream. Additionally, a user or an administrator can group multiple tags into a group, as described with respect to FIG. 4.

At operation 520, the processing logic inspects respective tags of the I/O streams. An I/O stream can have multiple tags providing different identification data to the QoS module. In one embodiment, QoS module 126 checks whether the tag is associated with a user-initiated I/O operation or an internal maintenance-related I/O operation. The QoS module 126 also checks which KVDB the tagged I/O stream corresponds to. Further, the QoS module can identify the user-initiated application to which the tag is associated, and what QoS parameter is associated with that user-initiated application.

At operation 530, based on the identification data obtained from inspecting the tags, the processing logic determines respective amounts of bandwidths to be provisioned to the I/O streams in order to satisfy a threshold criterion pertaining to a predetermined QoS parameter associated with the I/O streams. The predetermined QoS parameter can be defined by an administrator, for example, using the QoS CLI module 360 shown in FIG. 3. The threshold criterion associated with the QoS parameter can be a maximum latency experienced by a user-initiated I/O operation without perceptible performance degradation. As described above with reference to FIG. 2, bandwidth provisioning can be within the I/O streams associated with a particular instance of a KVDB. When there are multiple instances of KVDB, the processor in the QoS module provisions total available bandwidth among the I/O streams spanning the multiple instances of KVDBs. In certain embodiments, more bandwidth can be provisioned to I/O streams containing user-initiated operations than I/O streams containing internal maintenance-related operations. However, as described with respect to the QoS tuning API module 360 shown in FIG. 3, bandwidth across throttling queues can be redistributed if the internal KVS tree data structure becomes so disorganized that the completing the user-initiated I/O operations becomes inefficient.

At operation 540, the processing logic dynamically throttles the I/O streams with the respective amounts of provisioned bandwidths across one or more KVDBs. Dynamic throttling involves regulating the processing time for I/O operations in the I/O streams. Dynamic throttling can be done by the module 250 shown in FIG. 2. The QoS module layer 370A-C in the I/O path in FIG. 3 accomplishes the dynamic throttling by communicating with the policy engine 380 via module 384. With proper bandwidth allocation based on information contained in the tags, throttling itself does not affect the QoS. Moreover, I/O streams can be multiplexed between the KVDBs by the module 250.

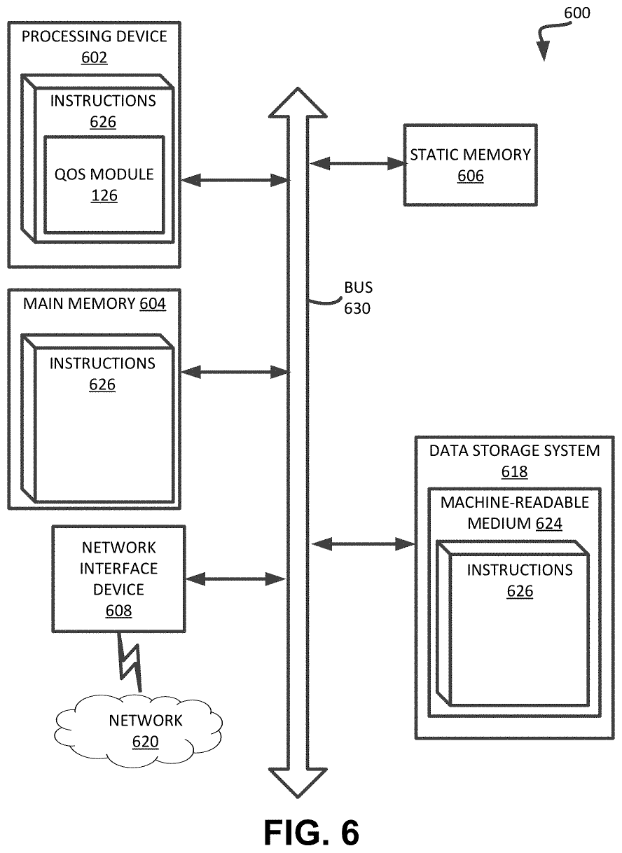

FIG. 6 illustrates an example machine of a computer system 600 within which a set of instructions, for causing the machine to perform any one or more of the methodologies discussed herein, can be executed. For example, the computer system 600 can correspond to a host system (e.g., the host system 120 of FIG. 1) that includes, is coupled to, or utilizes a memory sub-system (e.g., the host system 110 of FIG. 1) or can be used to perform the operations of a controller (e.g., to execute an operating system to perform operations corresponding to the QoS module 126 of FIG. 1). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, a central processing unit, or the like. More particularly, the processing device can be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 6026 for performing the operations and steps discussed herein. The computer system 600 can further include a network interface device 608 to communicate over the network 620. The data storage device 618 can include a machine-readable storage medium 624 (also known as a computer-readable medium) on which is stored one or more sets of instructions or software 626 embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage device 618, and/or main memory 604 can correspond to the memory sub-system 110 of FIG. 1.

In one implementation, the instructions 626 include instructions to implement functionality corresponding to a specific component (e.g., QoS module 126 of FIG. 1). While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving” or “servicing” or “issuing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus can be specially constructed for the intended purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A method comprising:
receiving one or more input/output streams associated with one or more key-value databases;
inspecting respective tags of the one or more input/output streams;
determining, based on identification data obtained from inspecting the respective tags, respective amounts of bandwidths to be provisioned to the one or more input/output streams in order to satisfy a threshold criterion pertaining to a predetermined quality-of-service (QoS) parameter associated with the one or more input/output streams; and
dynamically throttling the one or more input/output streams with the respective amounts of provisioned bandwidths across the one or more key-value databases to regulate processing time for input/output operations in the one or more input/output streams in accordance with the QoS parameter.

2. The method of claim 1, wherein at least one of the one or more input/output streams comprises one or more user-initiated input/output operations associated with accessing data stored in a memory sub-system coupled with the one or more key-value databases.

3. The method of claim 2, wherein inspecting a respective tag comprises:
obtaining identification data that associates the one or more user-initiated input/output operations with a corresponding application executed at a host computer system.

4. The method of claim 2, wherein at least one of the one or more input/output streams comprises internal maintenance-related input/output operations for the one or more key-value databases.

5. The method of claim 4, wherein inspecting a respective tag comprises:
obtaining identification data that associates an input/output stream with a corresponding key-value database.

6. The method of claim 1, wherein each key-value database comprises one or more key-value stores.

7. The method of claim 1, wherein determining the amount of bandwidth to be provisioned to the one or more input/output streams comprises:
determining a latency associated with completing one or more user-initiated or internal maintenance-related input/output operations included in an input/output stream; and
determining whether the determined latency satisfies a threshold latency pertaining to the predetermined QoS parameter associated with the input/output stream.

8. The method of claim 1, further comprising:
mapping the one or more key-value databases along with the corresponding input/output streams for each key-value database; and
multiplexing between the input/output streams across the one or more key-value databases.

9. The method of claim 1, further comprising:
providing a first interface for receiving, from a user, a group definition including one or more tags belonging to the one or more input/output streams.

10. The method of claim 9, further comprising:
providing a second interface for receiving, from the user, a weight assigned to a group of tags.

11. A system comprising:
a plurality of memory components; and
a processing device, operatively coupled to the memory components, to perform operations comprising:
providing an interface to assign respective tags to one or more input/output streams associated with one or more key-value databases, wherein a respective tag contains identification data regarding with which key-value database an input/output stream is associated;
determining, based on identification data obtained from the respective tags, an amount of bandwidth to be provisioned to the one or more input/output streams in order to satisfy a threshold latency value; and
dynamically throttling the one or more input/output streams with the respective amounts of provisioned bandwidths across the one or more key-value databases to regulate processing time for input/output operations in the one or more input/output streams in accordance with the threshold latency value.

12. The system of claim 11, wherein the threshold latency value pertains to a predetermined quality-of-service (QoS) parameter associated with the one or more input/output streams.

13. The system of claim 11, wherein the processing device is further to perform operations comprising:
determining, based on the tag, whether an input/output stream contains user-initiated operations.

14. The system of claim 13, wherein the processing device is further to perform operations comprising:
responsive to determining that a first input/output stream contains user-initiated input/output operations, provisioning more bandwidth to the first input/output stream compared to a second input/output stream that contains internal maintenance-related input/output operations.

15. The system of claim 11, wherein each key-value database comprises one or more key-value stores.

16. The system of claim 11, wherein the processing device is further to perform operations comprising:
receiving, from a user via the interface, a priority level of a user-initiated input/output operation included in an input/output stream.

17. The system of claim 11, wherein the interface provides a plurality of tags associated with varying priority levels, from which an appropriate tag is selected by the user to indicate a priority level of the user-initiated input/output operation included in the input/output stream.

18. The system of claim 11, wherein the interface provides a plurality of tags for a database administrator to indicate that an input/output operation is related to internal maintenance of a corresponding key value database.

19. A non-transitory computer readable medium comprising instructions, which when executed by a processor, cause the processor to perform operations comprising:
receiving one or more input/output streams associated with one or more key-value databases;
inspecting respective tags of the one or more input/output streams;
determining, based on identification data obtained from inspecting the respective tags, respective amounts of bandwidths to be provisioned to the one or more input/output streams in order to satisfy a threshold criterion pertaining to a predetermined quality-of-service (QoS) parameter associated with the one or more input/output streams; and
dynamically throttling the one or more input/output streams with the respective amounts of provisioned bandwidths across the one or more key-value databases to regulate processing time for input/output operations in the one or more input/output streams in accordance with the QoS parameter.

20. The non-transitory computer readable medium of claim 19, wherein the one or more input/output streams comprise one or more user-initiated input/output operations associated with accessing data stored in a memory sub-system coupled with the one or more key-value databases.
